(19) United States
(12) Patent Application Publication
(10) Pub. No.: US 2026/0155400 A1
(43) Pub. Date: Jun. 4, 2026

(54) SEPARATOR STRUCTURE

(71) Applicant: TOYOTA JIDOSHA KABUSHIKI KAISHA, Toyota-shi Aichi-ken (JP)

(72) Inventors: Kazunori SHIBATA, Mishima-shi Shizuoka-ken (JP); Kotaro IKEDA, Susono-shi Shizuoka-ken (JP); Rannosuke MAEDA, Susono-shi Shizuoka-ken (JP)

(73) Assignee: TOYOTA JIDOSHA KABUSHIKI KAISHA, Toyota-shi Aichi-ken (JP)

(21) Appl. No.: 19/398,560

(22) Filed: Nov. 24, 2025

(30) Foreign Application Priority Data
Nov. 29, 2024 (JP) 2024-207836

(51) Int. Cl. H01M 8/0254; H01M 8/0276; H01M 8/10

(52) U.S. Cl. CPC H01M 8/0254; H01M 8/0276; H01M 2008/1095

(57) ABSTRACT

Each plate includes: a rectangular plate body; and a seal structure unit provided along an outer periphery of the plate body and projecting in a thickness direction of the plate body from the plate body. The seal structure unit includes: a band-shaped flat part separated in the thickness direction from the plate body and provided parallel to the plate body; a first connection part connecting the plate body and one end of the flat part in a width direction thereof to each other; and a second connection part connecting the plate body and the other end of the flat part in the width direction to each other. A boundary between the plate body and the first connection part and a boundary between the plate body and the second connection part are each formed into a linear shape when viewed in the thickness direction. The other end is formed into a concave-convex shape when viewed in the thickness direction.

### CROSS REFERENCE TO RELATED APPLICATIONS

The present application claims priority from Japanese patent application 2024-207836 filed on November 29, 2024, the disclosure of which is hereby incorporated in its entirety by reference into the present application.

### BACKGROUND

### FIELD

The present disclosure relates to a separator structure.

### RELATED ART

Various techniques have been suggested in relation to a separator used in a fuel cell. As an example, Japanese Patent Application Publication No. 2020-161220 discloses a separator with a seal structure unit (also called a “bead”) provided along an outer periphery thereof for sealing a reaction gas or a cooling medium. In a plan view, this seal structure unit includes meandering lateral parts in a pair, and a linearly-extending flat part interposed between the lateral parts in a pair. While rigidity to withstand a compressive load is enhanced using the meandering lateral parts, a seal length of the seal structure unit is shortened using the linearly-extending flat part.

However, the meandering shapes of the lateral parts increase the width of the seal structure unit. This makes size reduction of the seal structure unit difficult. Thus, a demand arises for a separator including a seal structure unit capable of being formed into a small width while improving the rigidity thereof.

### SUMMARY

The present disclosure is feasible in the following aspects.

According to one aspect of the present disclosure, a separator structure is provided. The separator structure has a configuration where plates in a pair are arranged face-to-face and joined to each other. Each of the plates includes: a rectangular plate body; and a seal structure unit extended along an outer periphery of the plate body and projecting in a thickness direction of the plate body from the plate body. The seal structure unit includes: a band-shaped flat part separated in the thickness direction from the plate body and provided parallel to the plate body; a first connection part connecting the plate body and one end of the flat part in a width direction thereof to each other; and a second connection part provided closer to an outer edge of the plate body than the first connection part, and connecting the plate body and the other end of the flat part in the width direction to each other. A boundary between the plate body and the first connection part and a boundary between the plate body and the second connection part are each formed into a linear shape when viewed in the thickness direction. The other end is formed into a concave-convex shape when viewed in the thickness direction.

### BRIEF DESCRIPTION OF THE DRAWINGS

FIG. 1 is a perspective view of a fuel cell where a separator structure according to one embodiment of the present disclosure is used;

FIG. 2 is a plan view of a cell;

FIG. 3 is a perspective view of a seal structure unit;

FIG. 4 is a view showing a section of the cell cut along a line IV-IV in FIGS. 2 and 3;

FIG. 5 is a view showing a section of the cell cut along a line V-V in FIGS. 2 and 3;

FIG. 6 is a plan view of a separator structure according to a second embodiment; and

FIG. 7 is a plan view of a separator structure according to a third embodiment.

### DETAILED DESCRIPTION

### A. First Embodiment

### <Configuration of Fuel Cell 100>

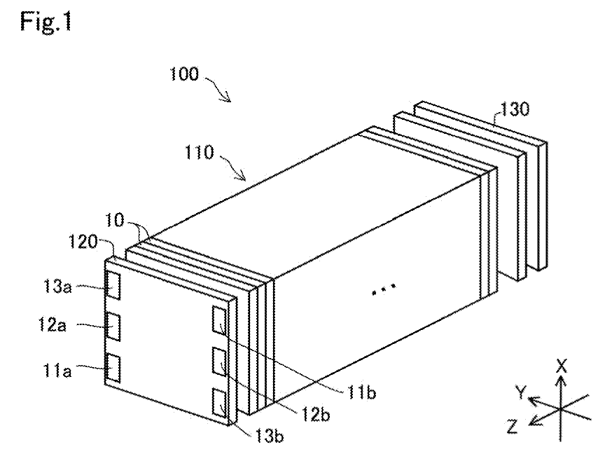

FIG. 1 is a perspective view of a fuel cell 100 where a separator structure 200 according to one embodiment of the present disclosure is used. FIG. 1 shows an X axis, a Y axis, and a Z axis orthogonal to each other. The fuel cell 100 is used as a power source for an electric vehicle, for example. The fuel cell 100 includes a cell stack 110, and terminal plates 120 and 130 in a pair.

The cell stack 110 is composed of a plurality of cells 10 stacked in the Z direction. The cell 10 is a solid polymer fuel cell that generates power using an oxidizing gas and a fuel gas. The cell 10 includes an electrolyte membrane, an anode catalyst layer stacked on one surface of the electrolyte membrane, a cathode catalyst layer stacked on the other surface of the electrolyte membrane, gas diffusion layers in a pair arranged in such a manner that the anode catalyst layer and the cathode catalyst layer are interposed therebetween, and separator structures in a pair arranged in such a manner that the gas diffusion layers in a pair are interposed therebetween.

The electrolyte membrane is a solid polymer membrane having a proton-conducting property. The electrolyte membrane is an ion-exchange membrane composed of a fluorine resin, for example. The anode catalyst layer contains a catalyst that accelerates chemical reaction of the fuel gas, and carbon particles supporting the catalyst. The cathode catalyst layer contains a catalyst that accelerates chemical reaction of the oxidizing gas, and carbon particles supporting the catalyst. The gas diffusion layers are each composed of a porous body. The porous body is prepared using metal or a carbon material. The gas diffusion layers diffuse the reaction gas uniformly to the cathode catalyst layer and the anode catalyst layer. The electrolyte membrane, the anode catalyst layer, the cathode catalyst layer, and the gas diffusion layers are collectively called a membrane electrode gas diffusion layer assembly (MEGA). The separator structures in a pair are arranged in such a manner that the membrane electrode gas diffusion layer assembly is interposed therebetween. The separator structures will be described later in detail.

The terminal plates 120 and 130 are arranged at both ends of the cell stack 110 in a stacking direction. The terminal plates 120 and 130 are each composed of a conductive material such as aluminum or copper. The terminal plates 120 and 130 are used for extracting power generated by the cells 10 to the outside.

The fuel cell 100 is provided with oxidizing gas manifolds 11a and 11b, cooling medium manifolds 12a and 12b, and fuel gas manifolds 13a and 13b. Each of these manifolds is composed of manifold holes formed at the separator structure 200 and at each of the terminal plates 120 and 130. The oxidizing gas manifold 11a is used for supplying the oxidizing gas to the fuel cell 100. The oxidizing gas manifold 11b is used for discharging the oxidizing gas from the fuel cell 100. The cooling medium manifold 12a is used for supplying a cooling medium to the fuel cell 100. The cooling medium manifold 12b is used for discharging the cooling medium from the fuel cell 100. The fuel gas manifold 13a is used for supplying the fuel gas to the fuel cell 100. The fuel gas manifold 13b is used for discharging the fuel gas from the fuel cell 100.

### <Configuration of Separator Structure 200>

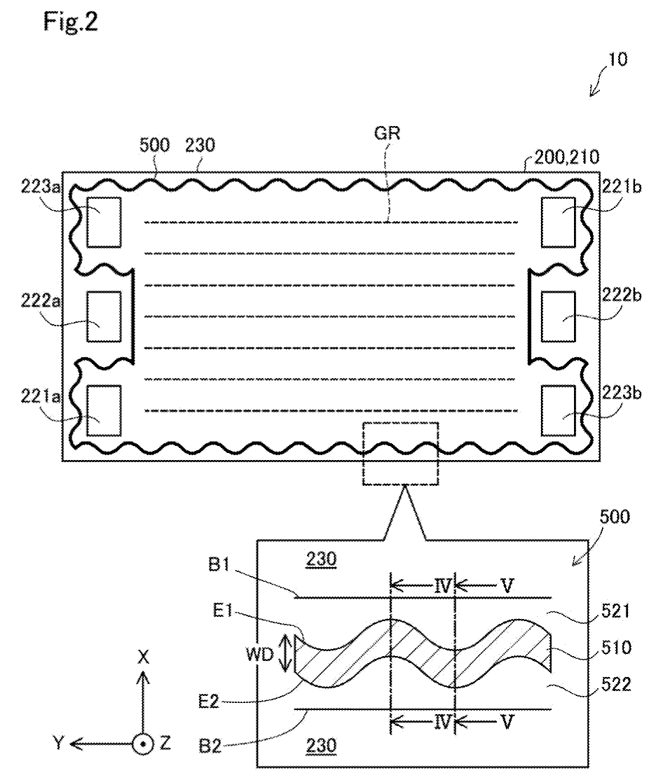

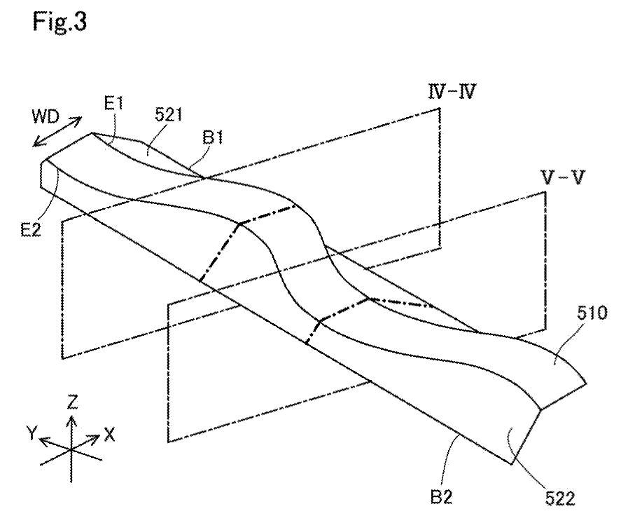

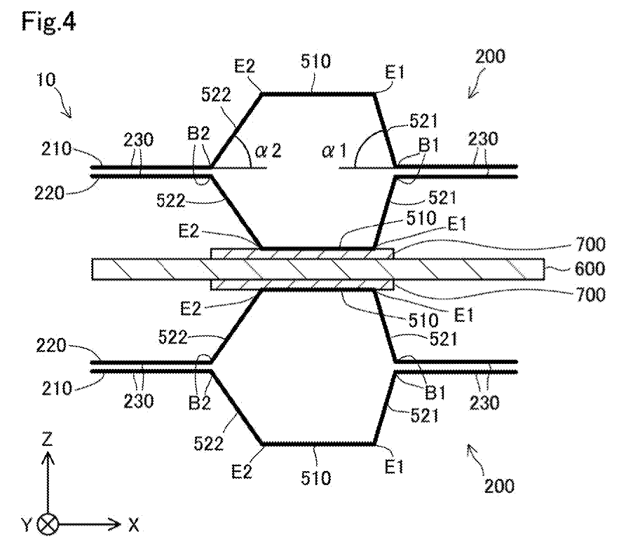

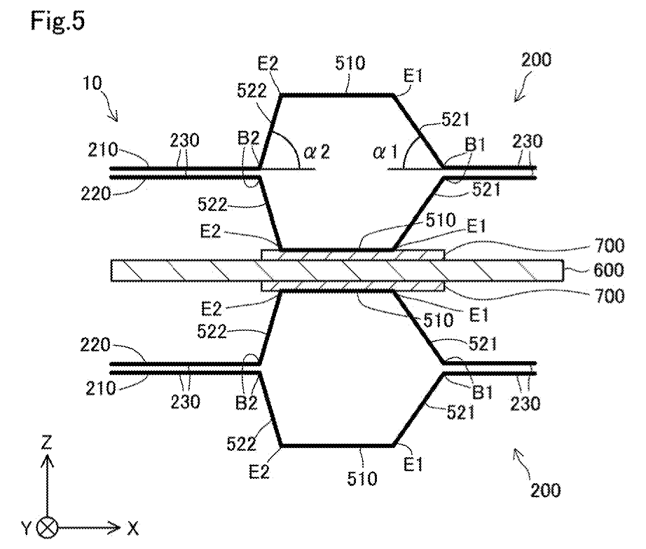

FIG. 2 is a plan view of the cell 10. Among the separator structures 200 of the cells 10, FIG. 2 shows the separator structure 200 located at an outermost position. A seal structure unit 500 described later is schematically shown in an enlarged manner in a lower section of FIG. 2. FIG. 3 is a perspective view of the seal structure unit 500. FIG. 4 is a view showing a section of the cell 10 cut along a line IV-IV in FIGS. 2 and 3. FIG. 5 is a view showing a section of the cell 10 cut along a line V-V in FIGS. 2 and 3. FIGS. 4 and 5 may also be said to be views each showing a section orthogonal to a direction in which the seal structure unit 500 extends. As shown in FIGS. 4 and 5, the separator structure 200 has a pair of plates 210 and 220 arranged face-to-face and joined to each other. The plates 210 and 220 have configurations symmetrical to each other. The plates 210 and 220 are each composed of a carbon material or a metallic material, for example.

As shown in FIG. 2, each of the plates 210 and 220 includes a plate body 230 and the seal structure unit 500.

### <Configuration of Plate Body 230>

The plate body 230 has a rectangular shape in a plan view. The plate body 230 is provided with six manifold holes 221a, 221b, 222a, 222b, 223a, and 223b. The manifold hole 221a is a part of the oxidizing gas manifold 11a. The manifold hole 221b is a part of the oxidizing gas manifold 11b. The manifold hole 222a is a part of the cooling medium manifold 12a. The manifold hole 222b is a part of the cooling medium manifold 12b. The manifold hole 223a is a part of the fuel gas manifold 13a. The manifold hole 223b is a part of the fuel gas manifold 13b.

The plate body 230 is provided with a plurality of grooves GR formed at a surface thereof on the side of the membrane electrode gas diffusion layer assembly and extending in a lengthwise direction (Y direction) of the plate body 230. All the grooves GR are aligned in a short-side direction (X direction) of the plate body 230. The grooves GR are used as a flow path for the reaction gas.

### <Configuration of Seal Structure Unit 500>

The seal structure unit 500 is provided along an outer periphery of the plate body 230. When viewed in a thickness direction (Z direction) of the plate body 230, the seal structure unit 500 is provided inside the plate body 230. When viewed in a thickness direction (Z direction) of the plate body 230, the seal structure unit 500 is provided external to a range where the membrane electrode gas diffusion layer assembly is arranged, in the plate body 230. When viewed in the thickness direction, the seal structure unit 500 is provided in such a manner as to surround parts of the manifold holes 221a, 221b, 223a, and 223b from an external side of the plate body 230 and is provided in such a manner as to surround parts of the manifold holes 222a and 222b from an internal side of the plate body 230. The seal structure unit 500 projects in the thickness direction of the plate body 230 from the plate body 230. The seal structure unit 500 prevents leakages of the cooling medium and the reaction gas. The seal structure unit 500 receives a load applied from a different adjacent cell.

As shown in FIGS. 2 to 5, the seal structure unit 500 includes a flat part 510, a first connection part 521, and a second connection part 522.

As shown in FIGS. 3 to 5, the flat part 510 is spaced apart from the plate body 230 in the thickness direction. The flat part 510 is provided parallel to the plate body 230. The flat part 510 may also be said to be a part having a flat surface parallel to the plate body 230. As shown in FIGS. 2 and 3, the flat part 510 is band-shaped. As shown in FIGS. 2 and 3, the flat part 510 has one end E1 and the other end E2 in a width direction WD thereof that are each formed into a concave-convex shape. The one end E1 and the other end E2 may be formed unevenly. The one end E1 and the other end E2 are apart from each other in the width direction of the flat part 510. The one end E1 is located closer to the internal side in a plan view of the plate body 230 than the other end E2. In the present embodiment, the one end E1 and the other end E2 are each formed into a sinusoidal wave shape. An amplitude, a wavelength, and a phase are substantially equal between the one end E1 and the other end E2. This makes the width of the flat part 510 substantially constant at any position.

As shown in FIGS. 2 to 5, the first connection part 521 connects the plate body 230 and the one end E1 to each other. As shown in FIG. 2, in the present disclosure, a boundary B1 between the first connection part 521 and the plate body 230 is formed into a linear shape when viewed in the thickness direction. The boundary B1 may also be said to be a part provided parallel to an outer edge of the plate body 230.

As shown in FIGS. 2 to 5, the second connection part 522 connects the plate body 230 and the other end E2 to each other. The second connection part 522 is provided closer to the outer edge of the plate body 230 than the first connection part 521. As shown in FIG. 2, in the present disclosure, a boundary B2 between the second connection part 522 and the plate body 230 is formed into a linear shape when viewed in the thickness direction. Like the boundary B1, the boundary B2 may also be said to be a part provided parallel to the outer edge of the plate body 230.

As shown in FIGS. 4 and 5, the first connection part 521 and the second connection part 522 form an angle α1 and an angle α2 to the plate body 230 respectively each differing between places at the seal structure unit 500. More specifically, the angles α1 and α2 differ for each portion of the seal structure 500 located at different positions along the longitudinal direction of the seal structure 500. In FIG. 4 showing the section in an area where the flat part 510 projects toward the plate body 230, the angle α1 is larger than the angle α2. By contrast, in FIG. 5 showing the section in an area where the flat part 510 projects toward the external side of the plate body 230, the angle α2 is larger than the angle α1. Each of the angles α1 and α2 increases and decreases repeatedly within a predetermined range in the direction in which the seal structure unit 500 extends, thereby forming each of the one end E1 and the other end E2 into a meandering pattern as shown in FIGS. 2 and 3.

As shown in FIGS. 4 and 5, the respective flat parts 510 of the separator structures 200 in a pair are joined indirectly to each other across an insulating frame 600 and gaskets 700. The insulating frame 600 insulates the separator structures 200 in a pair from each other and suppresses outflow of the reaction gas. The gaskets 700 are provided in a pair in such a manner that the insulating frame 600 is interposed therebetween. The gaskets 700 suppress outflow of the reaction gas.

In the separator structure 200 of the first embodiment described above, the boundary B1 between the plate body 230 and the first connection part 521 and the boundary B2 between the plate body 230 and the second connection part 522 are each formed into a linear shape when viewed in the thickness direction. This makes it possible to reduce the width of the seal structure unit 500 while ensuring the rigidity of the seal structure unit 500, compared to a configuration where the boundary B1 and the boundary B2 are each formed into a shape such as a concave-convex shape, for example, other than a linear shape.

The one end E1 and the other end E2 of the flat part 510 are each formed into a concave-convex shape when viewed in the thickness direction. This allows force applied in the thickness direction to be distributed to achieve improvement of the rigidity of the seal structure unit 500, compared to a configuration where the one end E1 and the other end E2 are each formed into a linear shape. Thus, when force is applied in the thickness direction, it is possible to reduce the occurrence of deviation of the position of the separator structure 200 from an intended position or displacement of the joined plate bodies 230 in a pair from each other.

The one end E1 and the other end E2 are each formed into a concave-convex shape when viewed in the thickness direction. This makes it possible to further improve rigidity to withstand force applied in the thickness direction, compared to a configuration where only one of the one end E1 and the other end E2 is formed into a concave-convex shape.

The one end E1 and the other end E2 of the flat part 510 are each formed into a sinusoidal wave shape when viewed in the thickness direction. Thus, force applied to the seal structure unit 500 in the thickness direction is allowed to be distributed further, compared to a configuration where the one end E1 and the other end E2 are each formed into a concave-convex shape such as a square wave shape, for example, other than a sinusoidal wave shape. This achieves further improvement of the rigidity of the seal structure unit 500.

### B. Second Embodiment

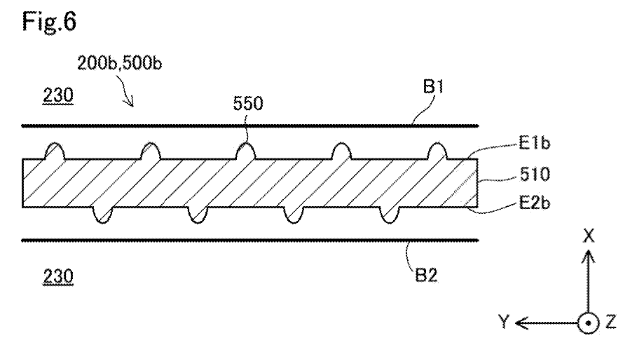

FIG. 6 is a plan view of a separator structure 200b according to a second embodiment. FIG. 6 shows the separator structure 200b viewed at a corresponding position to the enlarged view in FIG. 2. The separator structure 200b of the second embodiment differs from the separator structure 200 of the first embodiment in the configurations of one end E1b and the other end E2b. Description of the other configurations of the separator structure 200b of the second embodiment will be omitted as these configurations are the same as those of the separator structure 200 of the first embodiment.

The one end E1b and the other end E2b each have a plurality of projections 550. The projections 550 extend in a direction orthogonal to a direction in which a seal structure unit 500b extends and in a direction parallel to the plate body 230. The projections 550 at the one end E1b and the projections 550 at the other end E2b are provided alternately in the direction in which the seal structure unit 500b extends. Each of the one end E1b and the other end E2b may also be said to be an end formed into a concave-convex shape when viewed in the thickness direction by the presence of the projections.

The separator structure 200b of the second embodiment described above achieves effects comparable to those achieved by the separator structure 200 of the first embodiment.

In the separator structure 200b of the second embodiment, the projections 550 at the one end E1b and the projections 550 at the other end E2b are provided alternately in the direction in which the seal structure unit 500b extends. Thus, a load applied in the thickness direction is allowed to be distributed further, compared to a configuration where the projections 550 at the one end E1b and the projections 550 at the other end E2b are provided at the same positions in the direction in which the seal structure unit 500b extends. This achieves further improvement of the rigidity of the seal structure unit 500b.

### C. Third Embodiment

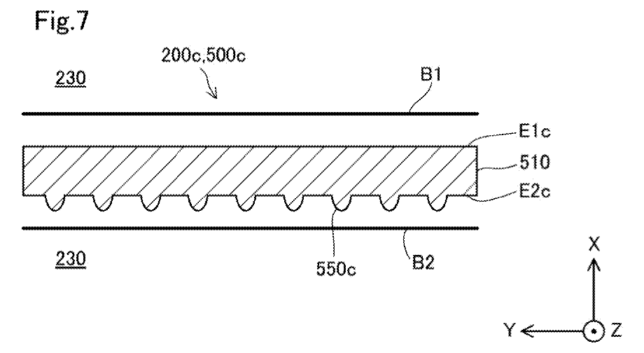

FIG. 7 is a plan view of a separator structure 200c according to a third embodiment. FIG. 7 shows the separator structure 200c viewed at a corresponding position to the enlarged view in FIG. 2. The separator structure 200c of the third embodiment differs from the separator structure 200b of the second embodiment in the locations of projections 550c. Description of the other configurations of the separator structure 200c of the third embodiment will be omitted as these configurations are the same as those of the separator structure 200b of the second embodiment.

In the separator structure 200c of the third embodiment, one end E1c is formed into a linear shape when viewed in the thickness direction, and only the other end E2c has the projections 550c.

In the separator structure 200c of the third embodiment described above, only the other end E2c has the projections 550c. This makes it possible to reduce deformation of a seal structure unit 500c toward an external side of the separator structure 200c when viewed in the thickness direction. More specifically, by the presence of structures on an internal side of the fuel cell 100 when viewed in the thickness direction such as the reaction gas flow path, the membrane electrode gas diffusion layer assembly, and others, deformation of the separator structure 200c toward the internal side is reduced. By contrast, as a result of a comparatively few structures or the absence of structures on the external side, deformation occurs more easily toward the external side than toward the internal side. In this regard, providing the projections 550c only at the other end E2c located on the external side of the plate body 230 like in the separator structure 200c of the third embodiment achieves improvement of rigidity at least at an external part of the seal structure unit 500c. This makes it possible to reduce deformation of the seal structure unit 500c toward the external side of the plate body 230.

### D. Other Embodiments

(D1) In the above-described first embodiment, the one end E1 and the other end E2 are each formed into a sinusoidal wave shape when viewed in the thickness direction. However, the present disclosure is not limited to this. Only the other end E2 may be formed into a sinusoidal wave shape. This embodiment achieves improvement of rigidity at least at an external part of the seal structure unit 500, making it possible to reduce deformation of the seal structure unit 500 toward an external side. In another case, each of the one end E1 and the other end E2 may be formed into an arbitrary concave-convex shape. As an example, each of the one end E1 and the other end E2 may be formed into a square wave shape.

(D2) In the above-described second embodiment, the projections 550 at the one end E1b and the projections 550 at the other end E2b are provided alternately in the direction in which the seal structure unit 500b extends. However, the present disclosure is not limited to this. The projections 550 at the one end E1b and the projections 550 at the other end E2b may be provided at the same positions in the direction in which the seal structure unit 500b extends.

(D3) In the above-described embodiments, the separator structures 200, 200b, and 200c are used in the fuel cells 100. Alternatively, the separator structures 200, 200b, and 200c may be used in water electrolysis cells.

The present disclosure is not limited to the embodiments described above and is able to be realized with various configurations without departing from the spirit thereof. For example, the technical features in the embodiments are able to be replaced with each other or combined together, as appropriate, in order to solve part or the whole of the problems described previously or to achieve part or the whole of the effects described previously. When the technical features are not described as required features in the present specification, they are able to be deleted, as appropriate. The present disclosure may be realized in the following aspects, for example.

(1) According to one aspect of the present disclosure, a separator structure is provided. The separator structure has a pair of plates arranged face-to-face and joined to each other. Each of the pair of plates includes: a rectangular plate body; and a seal structure unit extended along an outer periphery of the plate body and projecting in a thickness direction of the plate body from the plate body. The seal structure unit includes: a band-like flat part spaced apart from the plate body in the thickness direction and provided parallel to the plate body; a first connection part connecting the plate body and one end of the flat part in a width direction thereof to each other; and a second connection part provided closer to an outer edge of the plate body than the first connection part, and connecting the plate body and the other end of the flat part in the width direction to each other. A boundary between the plate body and the first connection part and a boundary between the plate body and the second connection part are each formed into a linear shape when viewed in the thickness direction. The other end is formed into a concave-convex shape when viewed in the thickness direction.

In this separator structure, the boundary between the plate body and the first connection part and the boundary between the plate body and the second connection part are each formed into a linear shape when viewed in the thickness direction. This makes it possible to reduce the width of the seal structure unit while ensuring seal characteristics, compared to a configuration where the boundaries are each formed into a shape such as a concave-convex shape, for example, other than a linear shape.

The other end of the flat part is formed into a concave-convex shape when viewed in the thickness direction. This allows force applied in a thickness direction of the seal structure unit to be distributed, compared to a configuration where the other end is formed into a linear shape. As a result, it is possible to improve the rigidity of the seal structure unit.

(2) In the separator structure of the above aspect, the one end may be formed into a concave-convex shape when viewed in the thickness direction.

In the separator structure of this aspect, the one end and the other end are each formed into a concave-convex shape when viewed in the thickness direction. Thus, force applied in the thickness direction of the seal structure unit is allowed to be distributed further, compared to a configuration where only the other end is formed into a concave-convex shape. This achieves further improvement of the rigidity of the seal structure unit.

(3) In the separator structure of the above aspect, the one end and the other end may each be formed into a sinusoidal wave shape when viewed in the thickness direction. In the separator structure of this aspect, the one end and the other end are each formed into a sinusoidal wave shape when viewed in the thickness direction. Thus, force applied to the seal structure unit in the thickness direction is allowed to be distributed further, compared to a configuration where the one end and the other end are each formed into a concave-convex shape such as a square wave shape, for example, other than a sinusoidal wave shape. This achieves further improvement of the rigidity of the seal structure unit.

What is claimed is:

1. A separator structure having a configuration having a pair of plates arranged face-to-face and joined to each other, wherein
each of the pair of plates includes:
a rectangular plate body; and
a seal structure unit provided along an outer periphery of the plate body and projecting in a thickness direction of the plate body from the plate body, wherein
the seal structure unit includes:
a band-shaped flat part spaced apart from the plate body in the thickness direction;
a first connection part connecting the plate body and one end of the flat part in a width direction thereof to each other; and
a second connection part provided closer to an outer edge of the plate body than the first connection part, and connecting the plate body and the other end of the flat part in the width direction to each other, wherein
a boundary between the plate body and the first connection part and a boundary between the plate body and the second connection part are each formed into a linear shape when viewed in the thickness direction, and
the other end is formed into a concave-convex shape when viewed in the thickness direction.

2. The separator structure according to claim 1, wherein
the one end is formed into a concave-convex shape when viewed in the thickness direction.

3. The separator structure according to claim 2, wherein
the one end and the other end are each formed into a sinusoidal wave shape when viewed in the thickness direction.
